(19) United States
(12) Patent Application Publication
(10) Pub. No.: US 2015/0276940 A1
(43) Pub. Date: Oct. 1, 2015

(54) RADIATION DETECTING DEVICE, MANUFACTURING METHOD FOR RADIATION DETECTING DEVICE

(71) Applicant: FUJIFILM Corporation, Tokyo (JP)

(72) Inventor: Hirotaka WATANO, Ashigarakami-gun (JP)

(73) Assignee: FUJIFILM Corporation, Tokyo (JP)

(21) Appl. No.: 14/556,589

(22) Filed: Dec. 1, 2014

(30) Foreign Application Priority Data
Mar. 25, 2014 (JP) 2014-062482

(51) Int. Cl. G01T 1/202; B32B 38/00; B32B 37/26; B32B 37/14; B29C 65/42; B32B 41/00

(52) U.S. Cl. CPC G01T 1/2023; B29C 65/42; B32B 41/00; B32B 37/26; B32B 37/144; B32B 38/0012; B29L 2009/00

(57) ABSTRACT

A radiation detecting device of the present invention includes a scintillator that converts radiation into light, a substrate that supports the scintillator and includes plural sensor portions that generate charges according to the light converted by the scintillator, a thermoplastic resin layer provided on the scintillator, a first organic layer provided on the thermoplastic resin layer, and an inorganic reflection layer provided on the first organic layer. The melting start temperature of the thermoplastic resin layer is lower than the melting start temperature of the first organic layer, the scintillator includes a projection portion on a surface on the side provided with the thermoplastic resin layer, and a leading end of the projection portion penetrates the thermoplastic resin layer and makes contact with the first organic layer.

### CROSS-REFERENCE TO RELATED APPLICATION

This application claims priority under 35 USC 119 from Japanese Patent Application, No. 2014-062482 filed Mar. 25, 2014, the disclosure of which is incorporated by reference herein.

### BACKGROUND

1. Technical Field

The present invention relates to a radiation detecting device and a manufacturing method for a radiation detecting device.

2. Related Art

Recently, radiation detection panels such as Flat Panel Detectors (FPDs) are being implemented in which a radiation sensitive layer is disposed on a Thin Film Transistor (TFT) active matrix substrate, and with which radiation can be converted directly into digital data. Radiation detecting devices, such as electronic cassettes, that employ such radiation detection panels to generate radiographic images expressing irradiated radiation are also being implemented. Methods used to convert radiation into electrical signals include an indirect conversion method, in which radiation is first converted into light with a scintillator and then the converted light is converted into charges with a photodiode, and a direct conversion method in which radiation is converted into charges with a semiconductor layer including amorphous selenium or the like. The known technology below relates to radiation detecting devices employing an indirect conversion method.

Japanese Patent Application Laid-Open (JP-A) No. 2012-172971 describes a flat panel detector in which a scintillator panel layered with a support body, a reflection layer, an undercoat layer, a phosphor layer and a protection layer is optically coupled together with a planar light receiving element including plural pixels arrayed in two-dimensions.

JP-A No. 2012-181108 describes a radiation detecting device including: a scintillator panel layered with a scintillator support substrate, a support substrate protection layer, a scintillator, an organic protection layer, an inorganic protection layer, and an organic protection layer; and a sensor panel including photoelectric conversion elements.

JP-A No. 2006-52980 describes a radiation detecting device including a sensor panel with a light receiving section made up of plural photoelectric conversion elements arrayed on a substrate, a phosphor layer that converts radiation into light that can be detected by the photoelectric conversion elements, and a columnar crystal structure provided using direct vapor deposition at least above the light receiving element, and a phosphor protection member including a phosphor protection layer that covers the phosphor layer and contacts the sensor panel. The phosphor protection layer is formed from a hot-melt resin containing light-reflecting fine particles.

JP-A No. 2006-52984 describes a radiation detecting device provided with a moisture-proof layer formed by a first hot-melt resin on a sensor substrate vapor deposited with a columnar phosphor, a second hot-melt layer formed on the first hot-melt resin, a reflection layer, and a reflection layer protection layer. In the radiation detecting device of JP-A No. 2006-52984, the melted viscosity at the processing temperature of the first hot-melt resin is higher than the melted viscosity at the processing temperature of the second hot-melt resin.

In a configuration in which, for example, a scintillator containing a halogen such as CsI (cesium iodide) or the like is disposed between a sensor substrate provided with a sensor portion including photoelectric conversion elements and an inorganic reflection layer such as Al (aluminum) or the like, there is a concern regarding corrosion of the inorganic reflection layer if the inorganic reflection layer directly contacts the scintillator. It is therefore preferable to dispose an anti-corrosion layer between the scintillator and the inorganic reflection layer in order to prevent corrosion of the inorganic reflection layer. It is also preferable to cover the scintillator with a moisture proof layer due to the high deliquescence of the scintillator.

However, an increase in the thickness of intermediate layers, such as the above anti-corrosion layer and moisture proof layer, increase the distance between the scintillator and the inorganic reflection layer, resulting in a drop in the sharpness of obtained radiographic images. Moreover, unless the flatness of the intermediate layers is secured, the flatness of the inorganic reflection layer is also compromised, with this also leading to a drop in the sharpness of obtained radiographic images.

In scintillators formed from an aggregation of columnar crystals such as CsI, it is known to be inevitable that abnormal growth occurs in some of the columnar crystals, resulting in projection portions that project out further at the surface of the scintillator than other portions. In such a configuration, in which an inorganic reflection layer is provided on a scintillator with surface projection portions, it is therefore not easy to control the distance between the scintillator and the inorganic reflection layer when intermediate layers are disposed between the scintillator and the inorganic reflection layer with the scintillator and the inorganic reflection layer in a non-contact state, nor is it easy to secure flatness of the inorganic reflection layer.

For example, JP-A No. 2006-52984 describes a configuration in which the two hot-melt layers of differing melted viscosities at their processing temperatures are provided between the columnar phosphor and the reflection layer. However, the hot-melt resins are melted by heating, making it difficult to control the layer thickness of the hot-melt layers. Namely, in the configuration described in JP-A No. 2006-52984, stable manufacture with a constant, uniform distance between the columnar phosphor and the reflection layer is difficult, and there are concerns of the columnar phosphor and the reflection layer contacting each other, or the distance between the columnar phosphor and the reflection layer exceeding a target value. Corrosion of the reflection layer occurs in the former case, and there is a drop in the sharpness of obtained radiographic images in the latter case.

### SUMMARY

In consideration of the above circumstances, the present invention provides radiation detecting device and a manufacturing method of a radiation detecting device that control the distance between a scintillator and an inorganic reflection layer while maintaining the scintillator and the inorganic reflection layer in a non-contact state, enabling the flatness of the inorganic reflection layer to be secured.

The radiation detecting device according to the present invention includes a scintillator that converts radiation into light, a substrate that supports the scintillator and includes plural sensor portions that generate charges according to the light converted by the scintillator, a thermoplastic resin layer provided on the scintillator, a first organic layer provided on the thermoplastic resin layer, and an inorganic reflection layer provided on the first organic layer. The melting start temperature of the thermoplastic resin layer is lower than the melting start temperature of the first organic layer. The scintillator includes a projection portion on a surface on the side provided with the thermoplastic resin layer, and a leading end of the projection portion penetrates the thermoplastic resin layer and makes contact with the first organic layer.

In the radiation detecting device according to the present invention, the scintillator may include plural projection portions on the surface on the side provided with the thermoplastic resin layer, and leading ends of at least some of the plural projection portions may penetrate through the thermoplastic resin layer and make contact with the first organic layer.

In the radiation detecting device according to the present invention, the scintillator may include plural projection portions that project out further than other portions on the surface on the side provided with the thermoplastic resin layer, and at least some of the plural projection portions out of the plural projection portions may be crushed, and leading ends of at least some of the crushed projection portions may penetrate through the thermoplastic resin layer and make contact with the first organic layer.

In the radiation detecting device according to the present invention, the scintillator may include plural columnar crystals, and the projection portion may be configured including a leading end portion of at least one columnar crystal higher than the average height of the plural columnar crystals.

In the radiation detecting device according to the present invention, the thermoplastic resin layer may be configured including a hot-melt resin.

In the radiation detecting device according to the present invention, a second organic layer may be further provided on the inorganic reflection layer.

A manufacturing method of a radiation detecting device according to the present invention includes: a forming process in which a scintillator is formed on a substrate; a preparation process in which a multi-layer is prepared including a thermoplastic resin layer that starts to melt at a first temperature and a first organic layer that starts to melt at a second temperature higher than the first temperature; a thermopress process in which the multi-layer is disposed on the scintillator such that the scintillator and the thermoplastic resin layer make contact with each other, and the multi-layer is pressed toward the scintillator while heating to a temperature higher than the first temperature and lower than the second temperature such that a projection portion of the scintillator penetrates the thermoplastic resin layer and makes contact with the first organic layer; and after the thermopress process, a process in which an inorganic reflection layer is formed on the first organic layer.

A manufacturing method of a radiation detecting device of the present invention includes: a forming process in which a scintillator is formed on a substrate; a preparation process in which a multi-layer is prepared including a thermoplastic resin layer that starts to melt at a first temperature, a first organic layer that is provided on the thermoplastic resin layer and starts to melt at a second temperature higher than the first temperature, and an inorganic reflection layer that is provided on the first organic layer; and a thermopress process in which the multi-layer is disposed on the scintillator such that the scintillator and the thermoplastic resin layer make contact with each other, and the multi-layer is pressed toward the scintillator while heating to a temperature higher than the first temperature and lower than the second temperature such that a projection portion of the scintillator penetrates the thermoplastic resin layer and makes contact with the first organic layer.

In the manufacturing method of a radiation detecting device according to the present invention, a multi-layer may be prepared in the preparation process further including a second organic layer provided on the inorganic reflection layer.

A manufacturing method of a radiation detecting device according to the present invention includes: a forming process in which a scintillator is formed on a substrate; a covering process in which a surface of the scintillator is covered by a thermoplastic resin layer that starts to melt at a first temperature; a thermopress process in which a layer including a first organic layer that starts to melt at a second temperature higher than the first temperature and an inorganic reflection layer provided on the first organic layer is disposed on the thermoplastic resin layer, and the first organic layer is pressed toward the scintillator while heating the thermoplastic resin layer to a temperature higher than the first temperature and lower than the second temperature such that a projection portion of the scintillator penetrates the thermoplastic resin layer and makes contact with the first organic layer.

In the manufacturing method of a radiation detecting device according to the present invention, in the thermopress process, a layer including a second organic layer provided on the inorganic reflection layer may be disposed on the thermoplastic resin layer.

The manufacturing method of the radiation detecting device according to the present invention may further include a crush shaping process that is performed prior to the thermopress process and in which the projection portion is crushed and the height of the projection portion is reduced.

In the manufacturing method of the radiation detecting device according to the present invention, in the crush shaping process the projection portion may be crushed such that the height of the projection portion achieves a specific threshold value or lower. Moreover, in the crush shaping process the projection portion is crushed such that the height of the projection portion is reduced to the thickness of the thermoplastic resin layer or lower.

In the manufacturing method of the radiation detecting device according to the present invention, a measurement process may be further included that is performed prior to the thermopress process and in which the height of the projection portion is measured, and the crush shaping process may be performed in cases in which the height of the projection portion measured in the measurement process is higher than a specific threshold value.

In the manufacturing method of the radiation detecting device according to the present invention, a measurement process may be further included that is performed prior to the thermopress process and in which the height of the projection portion is measured, and the crush shaping process may include processing to impart pressing force to the projection portion, wherein the pressing force is determined based on the height of the projection portion measured in the measurement process.

In the manufacturing method of the radiation detecting device according to the present invention, the thermoplastic resin layer may be configured including a hot-melt resin.

### BRIEF DESCRIPTION OF THE DRAWINGS

Exemplary Embodiments of the present invention will be described in detail based on the following figures, wherein:

FIG. 1 is a perspective view illustrating a configuration of a radiation detecting device according to an exemplary embodiment of the present invention;

FIG. 2 is a cross-section of a radiation detecting device according to an exemplary embodiment of the present invention;

FIG. 3 is a plan view of a radiation detection panel according to an exemplary embodiment of the present invention;

FIG. 4 is a diagram illustrating an electrical configuration of a radiation detecting device according to an exemplary embodiment of the present invention;

FIG. 5 is a partial cross-section of a radiation detection panel according to an exemplary embodiment of the present invention;

FIG. 6 is a process flow diagram illustrating a manufacturing method of a radiation detecting device according to an exemplary embodiment of the present invention;

FIG. 7 is a diagram illustrating an example of a method to laminate an organic layer and an inorganic reflection layer together according to an exemplary embodiment of the present invention;

FIG. 8 is a diagram illustrating an example of a thermoplastic resin layer coating method according to an exemplary embodiment of the present invention;

FIG. 9A is a diagram illustrating an example of a method of thermopress processing according to an exemplary embodiment of the present invention;

FIG. 9B is a diagram illustrating an example of a method of thermopress processing according to an exemplary embodiment of the present invention;

FIG. 10A is a cross-section of a radiation detection panel during thermopress processing according to an exemplary embodiment of the present invention;

FIG. 10B is a cross-section of a radiation detection panel during thermopress processing according to an exemplary embodiment of the present invention;

FIG. 11 is process flow diagram illustrating a manufacturing method of a radiation detecting device according to an exemplary embodiment of the present invention;

FIG. 12 is a cross-section of a scintillator formed on a sensor substrate according to an exemplary embodiment of the present invention;

FIG. 13A is a diagram illustrating an example of a method of crush shaping according to an exemplary embodiment of the present invention;

FIG. 13B is a diagram illustrating an example of a method of crush shaping according to an exemplary embodiment of the present invention;

FIG. 14 is a cross-section of a scintillator after crush shaping according to an exemplary embodiment of the present invention;

FIG. 15 is a partial cross-section of a radiation detection panel according to an exemplary embodiment of the present invention;

FIG. 16 is a process flow diagram illustrating a manufacturing method of a radiation detecting device according to an exemplary embodiment of the present invention;

FIG. 17 is a process flow diagram illustrating a manufacturing method of a radiation detecting device according to an exemplary embodiment of the present invention;

FIG. 18 is a diagram illustrating an example of a method of coating a thermoplastic resin layer according to an exemplary embodiment of the present invention;

FIG. 19 is a partial cross-section of a radiation detection panel according to an exemplary embodiment of the present invention;

FIG. 20 is a process flow diagram illustrating a manufacturing method of a radiation detecting device according to an exemplary embodiment of the present invention; and

FIG. 21 is a process flow diagram illustrating a manufacturing method of a radiation detecting device according to an exemplary embodiment of the present invention.

### DETAILED DESCRIPTION

Detailed explanation follows regarding exemplary embodiments of the present invention, with reference to the drawings. The same configuration elements are appended with the same reference numerals in each of the drawings.

### First Exemplary Embodiment

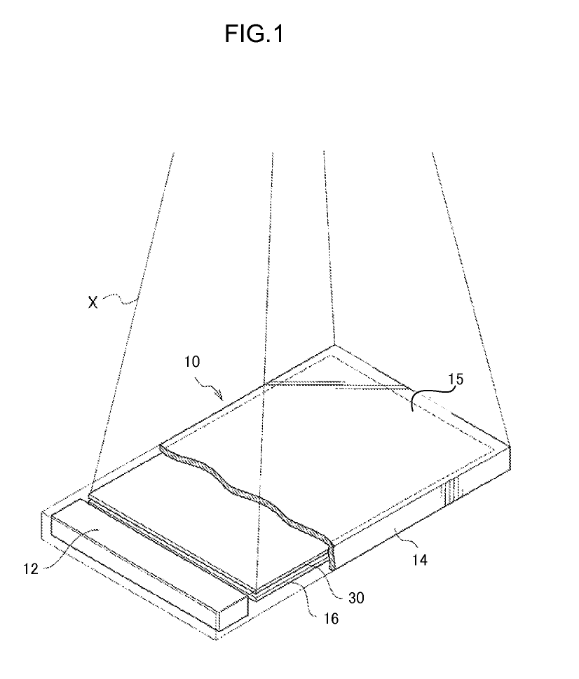

FIG. 1 is a perspective view illustrating a configuration of a radiation detecting device 10 according to an exemplary embodiment of the present invention. The radiation detecting device 10 has a portable electronic cassette form, and is configured including a radiation detection panel 30 (FPD), a control unit 12, a support plate 16, and a casing 14 that houses the control unit 12 and the support plate 16.

The casing 14 has, for example, a monocoque structure configured by a carbon fiber reinforced resin (carbon fiber) having high durability whilst having high transparency to X-rays and a light weight. The top face of the casing 14 configures an X-ray incident face 15 incident with X-rays that have been irradiated from an X-ray source (not illustrated in the drawings) and passed through an imaging subject (not illustrated in the drawings). The radiation detection panel 30 and the support plate 16 are disposed in this sequence inside the casing 14, from the X-ray incident face 15 side.

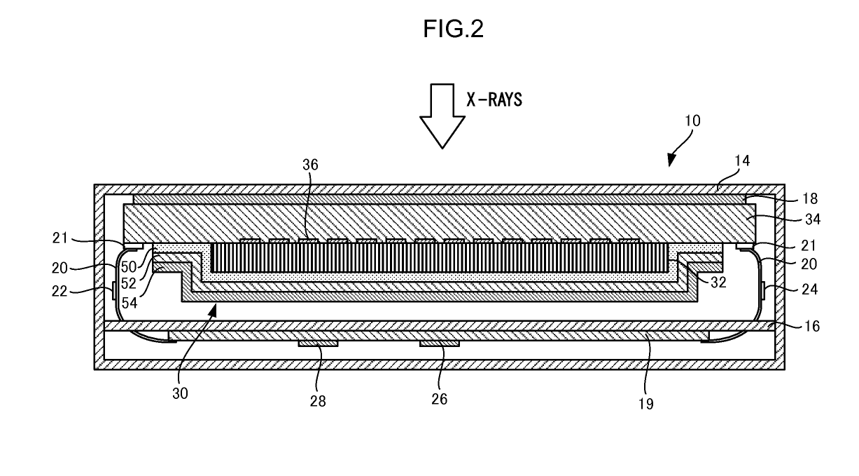

The support plate 16 is fixed to the casing 14, and supports a circuit board 19 (see FIG. 2) mounted with integrated circuit (IC) chips that perform signal processing and the like. The control unit 12 is disposed at an end portion inside the casing 14.

The control unit 12 is configured including a microcomputer and battery (neither of which is illustrated in the drawings). The microcomputer configuring the control unit 12 controls operation of the radiation detecting device 10 and is in communication with a console (not illustrated in the drawings) connected to the X-ray source through a wired or wireless communication section (not illustrated in the drawings).

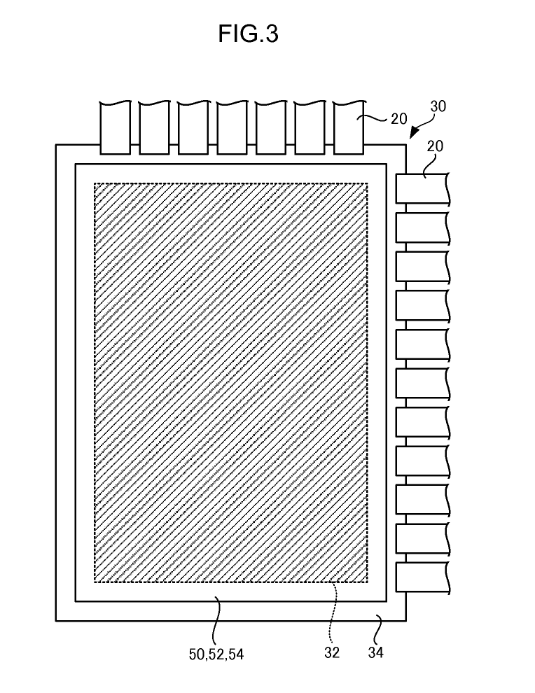

FIG. 2 is a cross-section of the radiation detecting device 10, and FIG. 3 is a plan view of the radiation detection panel 30. The radiation detection panel 30 is configured including a scintillator 32 containing a phosphor that converts X-rays into light, a sensor substrate 34 including plural sensor portions 36 that correspond to pixels and generate charge based on light emitted from the scintillator 32, and a thermoplastic resin layer 50, organic layer 52, and inorganic reflection layer 54 that are provided so as to cover the surface and side faces of the scintillator 32. The sensor substrate 34 is an example of a substrate that supports the scintillator of the present invention.

The X-ray incident side of the sensor substrate 34 is stuck to the X-ray incident side of the casing 14 using a bonding layer 18, such as a polyimide.

The scintillator 32 is configured including an aggregation of columnar crystals containing thallium-activated cesium iodide (CsI (Tl)), for example. The columnar crystals of CsI (Tl) may be formed on the sensor substrate 34 by vapor deposition. Employing CsI (Tl) as the scintillator 32 enables a light emission spectrum of from 400 nm to 700 nm to be achieved on X-ray absorption.

The radiation detecting device 10 has the sensor substrate 34 disposed at the X-ray incident side, and is employed in an imaging method using what is referred to as an irradiation side sampling (ISS) method. Employing irradiation side sampling enables the separation between the high intensity emission position in the scintillator 32 and the sensor portions 36 on the sensor substrate 34 to be made shorter than in cases of what is referred to as penetration side sampling (PSS) in which the scintillator 32 is disposed at the X-ray incident side. The resolution of radiographic images can be raised as a result. The radiation detecting device 10 may, however, also be employed in a penetration side sampling method.

The thermoplastic resin layer 50, the organic layer 52, and the inorganic reflection layer 54 are provided so as to cover the top face and the side faces of the scintillator 32, and to cover the sensor substrate 34 at the vicinity of the periphery of the scintillator 32. Detailed explanation is given below regarding the thermoplastic resin layer 50, the organic layer 52, and the inorganic reflection layer 54.

The support plate 16 is disposed on the opposite side of the scintillator 32 to the X-ray incident side. A gap is provided between the support plate 16 and the scintillator 32. The support plate 16 is fixed to side sections of the casing 14 by screws or the like. The circuit board 19 is fixed to the lower face of the support plate 16, on the opposite side to that of the scintillator 32 using a bonding agent or the like.

The circuit board 19 and the sensor substrate 34 are electrically connected together through wiring printed on a flexible printed wiring substrate 20. The flexible printed wiring substrate 20 is connected to external terminals 21 provided at edges of the sensor substrate 34 by employing a tape automated bonding (TAB) method.

A gate line driver 22 that drives the sensor substrate 34, and charge amplifiers 24 that convert charges output from the sensor substrate 34 into voltage signals are mounted to the flexible printed wiring substrate 20 as integrated circuit (IC) chips. A signal processor 26 that generates image data based on the voltage signals converted by the charge amplifiers 24, and an image memory 28 that stores image data, are mounted to the circuit board 19.

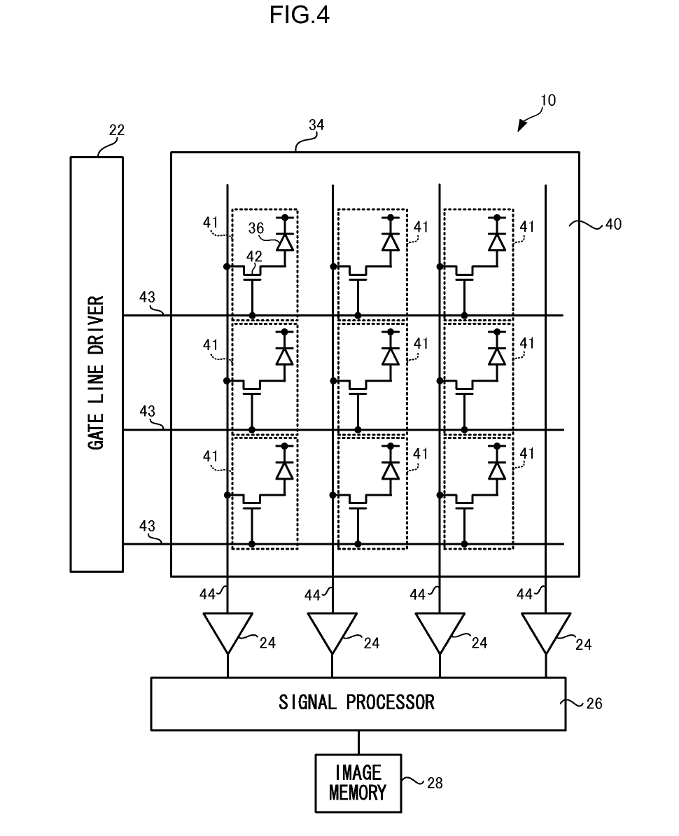

FIG. 4 is a diagram illustrating an electrical configuration of the radiation detecting device 10. The sensor substrate 34 is configured with plural pixels 41 arrayed in a matrix formation on the front face of an insulating substrate 40 configured from an insulator such as glass. Each of the pixels 41 include the sensor portions 36, configured by photoelectric conversion elements, such as photodiodes, that generate charges according to light emitted from the scintillator 32, and thin film transistors (TFT) 42 that serve as switching elements and adopt an ON state during reading of the charges generated in the sensor portions 36.

The sensor substrate 34 includes gate lines 43 that extend along a specific direction (row direction) along which the pixels 41 are arrayed on the front face of the insulating substrate 40. The sensor substrate 34 also includes signal lines 44 that extend along a direction (column direction) that intersects with the extension direction of the gate lines 43 on the front face of the insulating substrate 40. Each of the pixels 41 is provided so as to correspond to respective intersection portions between the gate lines 43 and the signal lines 44.

Each of the gate lines 43 is connected to the gate line driver 22 through the flexible printed wiring substrate 20. Each of the signal lines 44 is connected to the respective charge amplifiers 24 through the flexible printed wiring substrate 20. The output terminals of the charge amplifiers 24 are connected to the signal processor 26, and the image memory 28 is connected to the signal processor 26.

X-rays that have been emitted from the X-ray source (not illustrated in the drawings) and passed through the imaging subject are incident through the X-ray incident face 15 of the radiation detecting device 10, and the scintillator 32 absorbs the X-rays and emits visible light. The sensor portions 36 of the sensor substrate 34 convert the light emitted from the scintillator 32 into charges, and accumulate the charges.

During radiographic image generation, the gate line driver 22 supplies a gate signal through the gate lines 43 to the TFTs 42. The TFTs 42 are placed in an ON state in row units by the gate signals supplied from the gate line driver 22 through the gate lines 43. The charges generated in the sensor portions 36 by the TFTs 42 being placed in the ON state are read to the signal lines 44 as electrical signals, and supplied to the charge amplifiers 24. The charge amplifiers 24 convert the charges read to the signal lines 44 into voltage signals, and supply the voltage signals to the signal processor 26.

The signal processor 26 includes sample-and-hold circuits (not illustrated in the drawings) and holds the voltage signals supplied from the charge amplifiers 24 in the sample-and-hold circuits. The output side of the sample-and-hold circuit is connected in sequence to a multiplexer (not illustrated in the drawings), and an analog-digital (A/D) converter (not illustrated in the drawings). The voltage signals held by the individual sample-and-hold circuits are input in sequence to the multiplexer and converted by the A/D converter into digital signals. The signal processor 26 generates image data from associated data of the digital signals generated by the A/D converter and positional data of the pixels 41, and supplies the image data to the image memory 28. The image memory 28 is a storage medium that stores the image data generated by the signal processor 26.

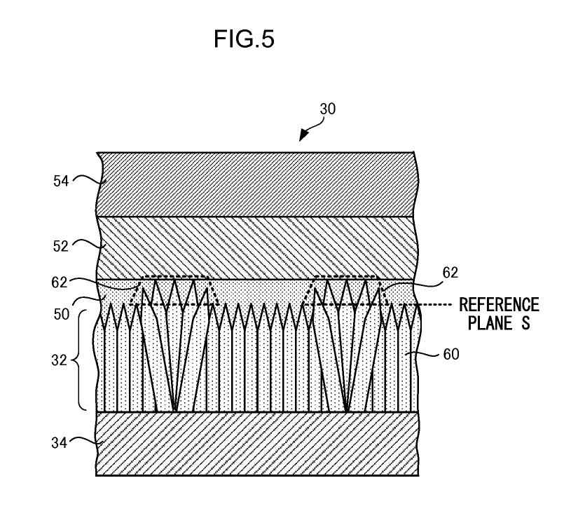

FIG. 5 is a partial cross-section illustrating a configuration of the radiation detection panel 30. The scintillator 32 is configured, as an example, by an aggregation of columnar crystals 60 containing CsI (Tl), and may be formed by vapor deposition on the sensor substrate 34. In the present exemplary embodiment an example is illustrated of a case in which the scintillator 32 is formed directly on the sensor substrate 34, however a protection layer, flattening layer, or the like of the sensor substrate 34 may be interposed between the sensor substrate 34 and the scintillator 32. Namely, in the present invention, “a substrate that supports the scintillator” encompasses configurations in which any layer is interposed between the scintillator and the substrate. Non-columnar crystals of CsI (Tl) may also be formed on the sensor substrate 34, with the columnar crystals grown on a foundation of the non-columnar crystals. The scintillator 32 is not limited to one including CsI (Tl), and may be configured from another material that has a columnar crystal structure such as, for example, CsI (Na), NaI (Tl), LiI (Eu), KI (Tl). The Young's modulus of all of these is about 5 Mpa.

Each of the columnar crystals 60 is separated from the adjacent columnar crystals 60 by an air layer, thereby providing a light-guide effect due to the difference in refractive index to that of the air layer. Due to the light-guide effect, the majority of the visible light emitted in each of the columnar crystals 60 propagates within the columnar crystal 60 and is incident to the sensor substrate 34. In the scintillator 32, it is inevitable that abnormal growth occurs in some of the columnar crystals, and that at least one projection portion 62 projects out further at the surface of the scintillator 32 than other portions. Namely, the projection portions 62 are configured including a leading end portion of at least one columnar crystal that is higher than the average height of the plural columnar crystals 60 configuring the scintillator 32. However, the leading end portions of the columnar crystals formed without abnormal growth occurring are substantially uniform in their height position, and are present in substantially the same plane as each other. The projection portions 62 are portions that project out from a reference plane S defined by the leading end portions of the columnar crystals formed without abnormal growth.

The top face and side faces of the scintillator 32 are covered by the thermoplastic resin layer 50. The thermoplastic resin layer 50 functions as a protection layer that protects the scintillator 32. Moisture is prevented from penetrating into the scintillator 32 by the thermoplastic resin layer 50 covering the scintillator 32, enabling deliquescence of the scintillator 32 to be prevented. A hot-melt resin may be suitably employed as the material for the thermoplastic resin layer 50. A hot-melt resin is solid at room temperature, and is an adhesive resin formed from a thermoplastic material that is 100% non-volatile, and does not contain water or solvent. Examples of materials that may be suitably employed as the hot-melt resin include an ethylene/vinyl acetate copolymer resin, an ethylene/acrylic acid copolymer resin, an ethylene/methacrylic acid copolymer, an ethylene/acrylic acid ester copolymer, or an ethylene/methacrylic acid ester copolymer. Commercial hot-melt resin products that may be suitably employed include, for example, POLYESTER SP170 (“POLYESTER” is a registered trademark, manufactured by Nippon Synthetic Chemical Co., Ltd.), Hirodine 7589 (manufactured by Yasuhara Chemical Co., Ltd.), and ARONMELT PES-111EE (ARONMELT is a registered trademark, manufactured by Toagosei Co., Ltd.). The melting point, adhesion temperature, and Young's modulus of each of these products are shown in Table 1.

TABLE 1

| | | Adhesion | Young's |
|---|---|---|---|
| Hot-melt resin product name | Melting point | temperature | modulus |
| POLYESTER SP170 | 83° C. | 120° C. | 0.01 GPA |
| Hirodine 7589 | 89° C. | 130° C. | 0.01 GPA |
| ARONMELT PES-111EE | 110° C. | 140° C. | 0.01 GPA |

The organic layer 52 is provided on the thermoplastic resin layer 50. The organic layer 52 is configured by an organic material (thermoplastic resin) having a higher melting start temperature (melting point) than the melting start temperature (melting point) of the thermoplastic resin layer 50. “Having a higher melting start temperature (melting point) than the melting start temperature (melting point) of the thermoplastic resin layer” means that the organic layer does not melt at the melting start temperature of the thermoplastic resin layer. The organic layer 52 may, accordingly, be configured not only by an organic material (thermoplastic resin) having a melting start temperature (melting point) higher than the melting start temperature (melting point) of the thermoplastic resin layer 50, but also by an organic material (thermoset resin) that does not have a melting point. Examples of materials that may be suitably employed as the organic layer 52 include polyethylene terephthalate (PET), polyethylene naphthalate (PEN), polyphenylene sulfide (PPS), polypropylene (PP), and polyimide (PI). The melting point and Young's modulus of each of the materials are shown in Table 2. PET, PEN, PPS, and PP are examples of organic materials (thermoplastic resins) having a higher melting start temperature (melting point) than the melting start temperature (melting point) of the thermoplastic resin layer 50. PI is an example of an organic material (thermoset resin) that does not have a melting point.

TABLE 2

| Organic layer candidate | | |
|---|---|---|
| material | Melting point | Young's modulus |
| PET | 255° C. | 2.2 GPA |
| PEN | 269° C. | 2.3 GPA |
| PPS | 290° C. | 3.0 GPA |
| PP | 164° C. | 1.5 GPA |
| PI | No melting point | 3.5 GPA |

The inorganic reflection layer 54 is provided on the organic layer 52. The inorganic reflection layer 54 has a function of reflecting light generated in the scintillator 32 toward the sensor substrate 34. Providing the inorganic reflection layer 54 enables the capture efficiency of the light generated in the scintillator 32 to be improved. The inorganic reflection layer 54 is preferably configured mainly from a material having specular reflectivity. Images with high sharpness are accordingly obtainable. Examples of materials suitably employed in the inorganic reflection layer 54 include Al, Al alloys, and Ag. Accordingly, the radiation detecting device 10 differs from the configuration described in JP-A No. 2006-52980 that includes a reflection layer configured from a material with diffuse reflectivity (more specifically from a hot-melt resin containing reflective fine particles) in the point that the radiation detecting device 10 according to the present invention is configured with a reflection layer from a material having specular reflectivity. Configuring the inorganic reflection layer from a material having specular reflectivity raises the sharpness of radiographic images obtained compared with cases configured with a material having diffuse reflectivity.

In the radiation detection panel 30 according to the present exemplary embodiment, contact between the scintillator 32 and the inorganic reflection layer 54 can be prevented due to providing the organic layer 52 between the scintillator 32 and the inorganic reflection layer 54. Corrosion of the inorganic reflection layer 54 due to contact of the scintillator 32 against the inorganic reflection layer 54 can thereby be prevented. The organic layer 52 functions as a protection layer of the inorganic reflection layer 54. Moreover, the flatness of the inorganic reflection layer 54 can be secured due to providing the organic layer 52 between the scintillator 32 and the inorganic reflection layer 54.

In the radiation detection panel 30 according to the present exemplary embodiment, at least a portion of the plural projection portions 62 formed on the surface of the scintillator 32 pierce through the thermoplastic resin layer 50 and make contact with the organic layer 52. Such “contact” includes both states in which the projection portions 62 of the scintillator 32 make contact with the lower face of the organic layer 52 and states in which the projection portions 62 press up the lower face of the organic layer 52 to an extent that does not form undulations on the upper face of the organic layer 52. Note that when the height of the plural projection portions 62 formed on the surface of the scintillator 32 is not uniform, the leading ends of the projection portions 62 with the highest height pierce through the thermoplastic resin layer 50 and make contact with the organic layer 52. The radiation detection panel 30 according to the present exemplary embodiment has a structure in which the leading ends of at least some of the plural projection portions 62 of the scintillator 32 pierce through the thermoplastic resin layer 50 and make contact with the organic layer 52. The distance from the reference plane S of the scintillator 32 to the inorganic reflection layer 54 is accordingly determined according to the height of the projection portions 62 and the layer thickness of the organic layer 52. The distance between the scintillator 32 and the inorganic reflection layer 54 can be controlled by the layer thickness of the organic layer 52.

Interposing a layer configured from an organic material with a lower Young's modulus than the configuration material of the inorganic reflection layer 54 (such as Al, Al alloy, Ag) between the scintillator 32 and the inorganic reflection layer 54 enables cracks to be suppressed from developing due to contact or the like with the scintillator 32. Supposing a layer configured from a material having a higher Young's modulus than the configuration material of the inorganic reflection layer 54 were to be interposed between the scintillator 32 and the inorganic reflection layer 54, then there would be a concern that cracks might develop in the layer configured from the material with the higher Young's modulus due to contact or the like with the scintillator 32. However, interposing a layer configured from an organic material with a lower Young's modulus than the configuration material of the inorganic reflection layer 54 between the scintillator 32 and the inorganic reflection layer 54 means that due to resilient deformation occurring, there is a high probability that damage can be avoided even in cases in which the organic material layer makes contact with the scintillator 32.

As described above, according to the radiation detecting device of the present exemplary embodiment of the invention, the distance between the scintillator and the inorganic reflection layer is controlled while maintaining the scintillator and the inorganic reflection layer in a non-contact state, enabling the flatness of the inorganic reflection layer to be secured.

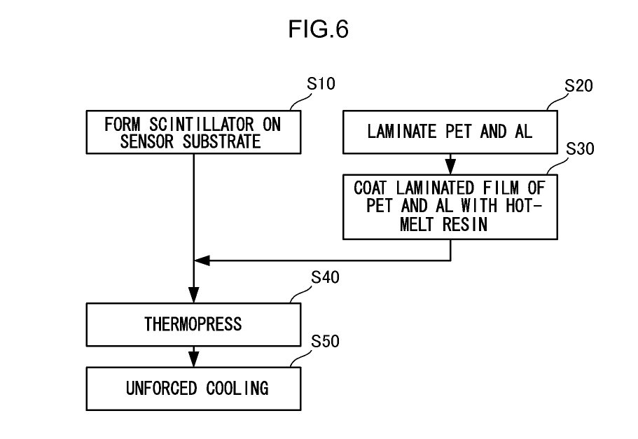

Explanation follows regarding a manufacturing method of the radiation detecting device 10. FIG. 6 is a process flow diagram illustrating a manufacturing method of the radiation detecting device 10 according to an exemplary embodiment of the present invention.

At process S10, the scintillator 32 is formed by vapor deposition on the sensor substrate 34 formed with the sensor portions 36, the gate lines 43, and the signal lines 44, etc. Explanation follows regarding an example of a case in which CsI (Tl) is employed as the scintillator 32; however, the present invention is not limited thereto. The vapor deposition processing of step S10 may, for example, be performed in the following sequence. First, the sensor substrate 34 is placed in a substrate holder of a vapor deposition apparatus. Then, the vapor deposition boat is filled with CsI and TlI, at a specific ratio. Then, after first evacuating the inside of the chamber of the vapor deposition apparatus, Ar gas is introduced, and the inside of the chamber is controlled to a specific vacuum. The sensor substrate 34 placed in the substrate holder is then heated to a specific temperature, and the CsI and TlI are vaporized by heating the vapor deposition boat to a specific temperature while rotating the sensor substrate 34. Columnar crystals of CsI (Tl) are thereby formed on the sensor substrate 34.

In the present exemplary embodiment, the scintillator 32 is formed directly on the sensor substrate 34; however, a protection layer, flattening layer, or the like of the sensor substrate 34 may be interposed between the sensor substrate 34 and the scintillator 32. Non-columnar crystals of CsI (Tl) may also be formed on the sensor substrate 34, with the columnar crystals grown on a foundation of the non-columnar crystals. The process S10 is an example of a forming process of the present invention.

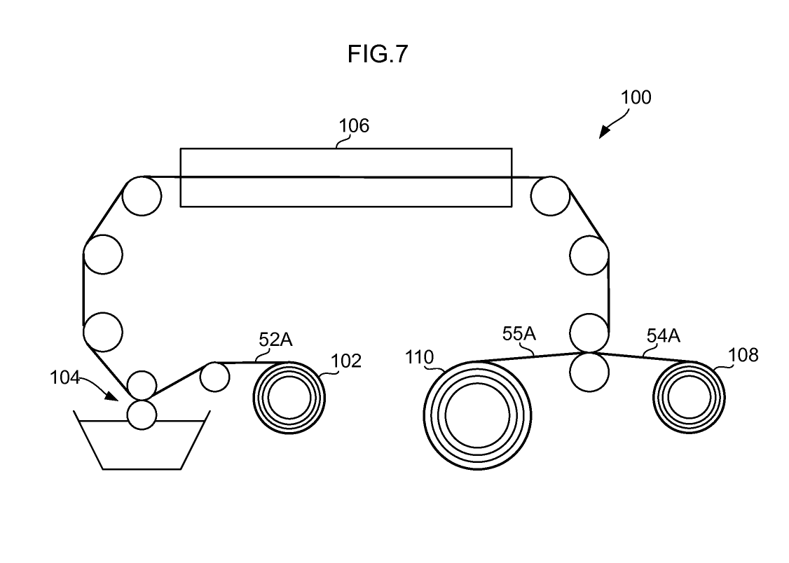

In a process S20, a configuration member of the organic layer 52 and a configuration member of the inorganic reflection layer 54 are laminated together. In the following explanation an example is explained in which a PET film is employed as the configuration member of the organic layer 52, and Al foil is employed as the configuration member of the inorganic reflection layer 54; however, the present invention is not limited thereto. FIG. 7 illustrates an example of a method of laminating together the PET film that is the configuration member of the organic layer 52, and the Al foil that is the configuration member of the inorganic reflection layer 54. Lamination of the PET film and the Al foil may be performed using, for example, a laminator 100. As illustrated in FIG. 7, in an adhesive coating section 104, one face of a PET film 52A being feed out from a roll 102 is applied with adhesive. The adhesive coated PET film 52A enters inside a drier 106 and solvent contained in the adhesive is driven off. Al foil 54A that configures the inorganic reflection layer 54 is fed out from a roll 108, and stuck to the adhesive coated PET film 52A. A laminated film 55A of the laminated together PET film 52A and Al foil 54A is then collected up on a roll 110.

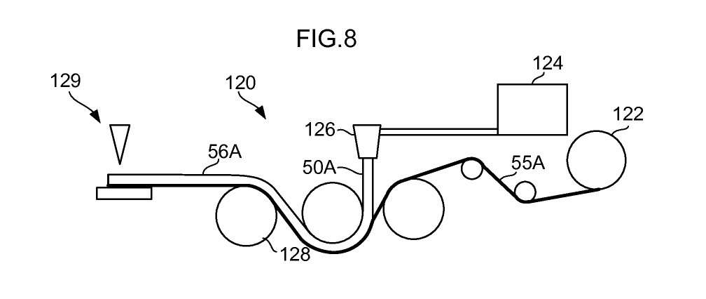

In a process S30, a configuration member of the thermoplastic resin layer 50 is coated onto the laminated film 55A produced at step S20. In the following explanation an example is explained in which a hot-melt resin is employed as the configuration member of the thermoplastic resin layer 50; however, the present invention is not limited thereto. FIG. 8 is a diagram illustrating an example of a coating method of the hot-melt resin. Coating of hot-melt resin onto the laminated film 55A may, for example, be performed by employing a coating device 120. The laminated film 55A of the laminated PET film 52A and Al foil 54A is fed out from a roll 122. A hot-melt resin 50A contained in a tank 124 is extruded from the leading end of a nozzle 126, so as to coat the PET film 52A side of the laminated film 55A. The hot-melt resin 50A is cooled and hardened by a cooling roller 128. A stacked-layer film 56A obtained by coating the hot-melt resin 50A onto the laminated film 55A is chopped into a specific size by a chopper 129. The stacked-layer film 56A is an example of a multi-layer of the present invention, and the process S30 and process S20 are an example of a preparatory process of the present invention. The manufacturing method according to the present exemplary embodiment includes the process S20 and process S30 to prepare the stacked-layer film 56A; however a pre-made externally fabricated stacked-layer film 56A may be employed. In such cases, the process S20 and process S30 to prepare the stacked-layer film 56A may be omitted.

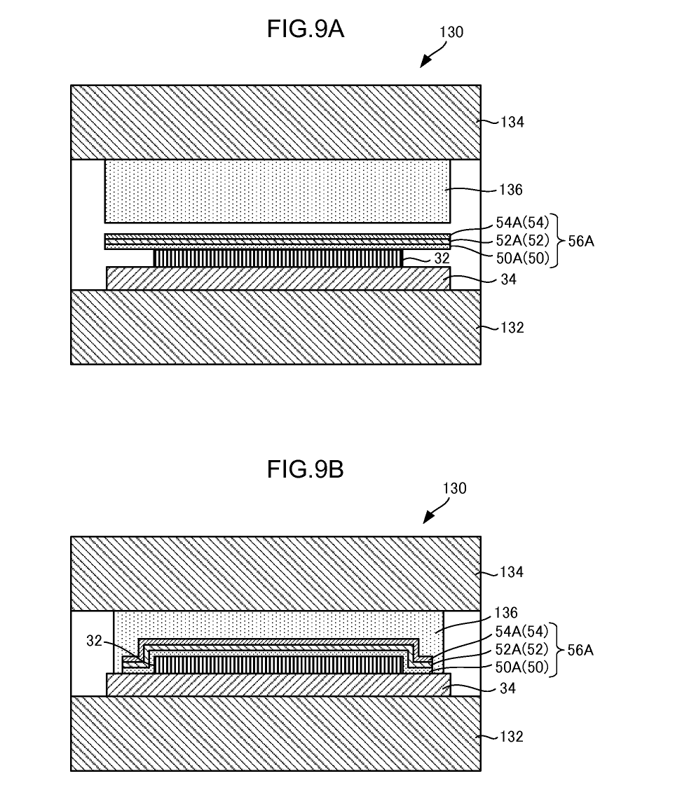

At a process S40, thermopress processing (thermocompression bonding) of the stacked-layer film 56A prepared at process S30 onto the scintillator 32 formed on the sensor substrate 34 is performed. FIG. 9A and FIG. 9B are diagrams illustrating an example of a method for thermopress processing. The thermopress processing to bond the stacked-layer film 56A onto the scintillator 32 may, for example, be performed using a press device 130. The press device 130 is configured including a stage 132 and a slider 134 affixed with a resilient member 136, such as sponge. The resilient member 136 may be configured from a diaphragm made from rubber or the like. The sensor substrate 34 formed with the scintillator 32 is mounted on the stage 132 of the press device 130, and the stacked-layer film 56A is laid over the scintillator 32 (FIG. 9A). The temperature of the internal space of the press device 130 is then heated to a temperature higher than the melting start temperature of the hot-melt resin 50A, but lower than the melting start temperature of the PET film 52A. The hot-melt resin 50A is thereby melted, however the PET film 52A remains solid. The resilient member 136 contacts the stacked-layer film 56A due to lowering the slider 134 toward the stage 132 side while maintaining the heated state, and pressing force acts on the stacked-layer film 56A so that the stacked-layer film 56A makes close contact with the scintillator 32 (FIG. 9B).

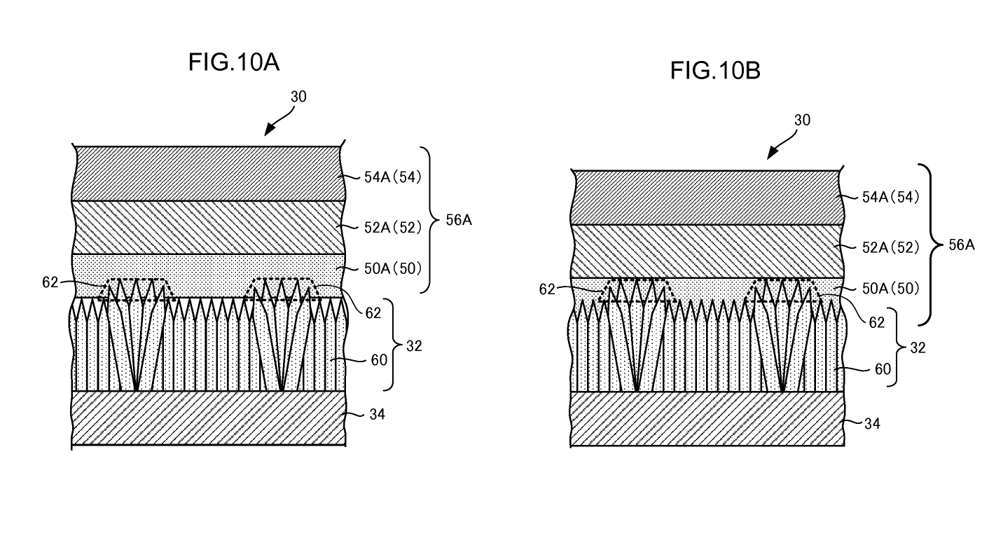

The hot-melt resin 50A is melted, and so, as illustrated in FIG. 10A, due to the pressure the plural projection portions 62 formed on the surface of the scintillator 32 penetrate into the hot-melt resin 50A. However, the PET film 52A maintains its solid state, and so, as illustrated in FIG. 10B, penetration of the projection portions 62 into the stacked-layer film 56A ceases at the point when the leading ends of the projection portions 62 make contact with the PET film 52A. In cases in which the height of the plural projection portions 62 formed to the surface of the scintillator 32 is non-uniform, penetration of the projection portions 62 into the stacked-layer film 56A ceases at the stage when the leading ends of the projection portions 62 with the highest height make contact with the PET film 52A. Namely, the PET film 52A functions as a stopper that stops the projection portions 62 from penetrating into the stacked-layer film 56A. The thermopress processing, as illustrated in FIG. 9B, bonds the stacked-layer film 56A onto the top face and side faces of the scintillator 32, and onto the sensor substrate 34 at a peripheral portion to the scintillator 32, such that the scintillator 32 is sealed by the stacked-layer film 56A.

A roller may be employed as the means to apply pressing force to the stacked-layer film 56A. In such cases, a roller applying pressing force to the stacked-layer film 56A is moved along a first direction across the entire region of the stacked-layer film 56A, and the roller is additionally moved along a second direction orthogonal to the first direction across the entire region of the stacked-layer film 56A. The stacked-layer film 56A and the scintillator 32 are thereby thermocompression bonded together. Either method is preferably performed under reduced atmospheric pressure. The process S40 is an example of the thermopress process of the present invention.

In a process S50, the hot-melt resin 50A is hardened by unforced cooling. Bonding of the stacked-layer film 56A together with the scintillator 32 and the sensor substrate 34 is thereby completed.

Thus according to the manufacturing method of the radiation detecting device 10 of the present exemplary embodiment, the stacked-layer film 56A is produced by stacking together the thermoplastic resin layer 50 that starts to melt at a first temperature, the organic layer 52 that starts to melt at a second temperature higher than the first temperature, and the inorganic reflection layer 54. When the stacked-layer film 56A is being bonded to the scintillator 32, the stacked-layer film 56A is heated to a temperature higher than the first temperature and lower than the second temperature, and pressed toward the scintillator 32. Namely, the organic layer 52 is pressed against the stacked-layer film 56A in a state in which the thermoplastic resin layer 50 is melted and the organic layer 52 remains solid. This thereby enables penetration of the projection portions 62 of the scintillator 32 into the stacked-layer film 56A to be stopped at the point when the leading ends of the projection portions 62 make contact with the organic layer 52. This thereby enables, as illustrated in FIG. 5, the radiation detection panel 30 to be obtained with a structure in which the leading ends of the projection portions 62 of the scintillator 32 pierce through the thermoplastic resin layer 50 and make contact with the organic layer 52. Thus, as described above, the distance between the scintillator 32 and the inorganic reflection layer 54 is controllable while maintaining the scintillator 32 and the inorganic reflection layer 54 in a non-contact state. Penetration of the projection portions 62 into the stacked-layer film 56A can be stopped at the point when the leading ends of the projection portions 62 on the scintillator 32 make contact with the organic layer 52, thereby enabling the flatness of the inorganic reflection layer 54 to be secured.

### Second Exemplary Embodiment

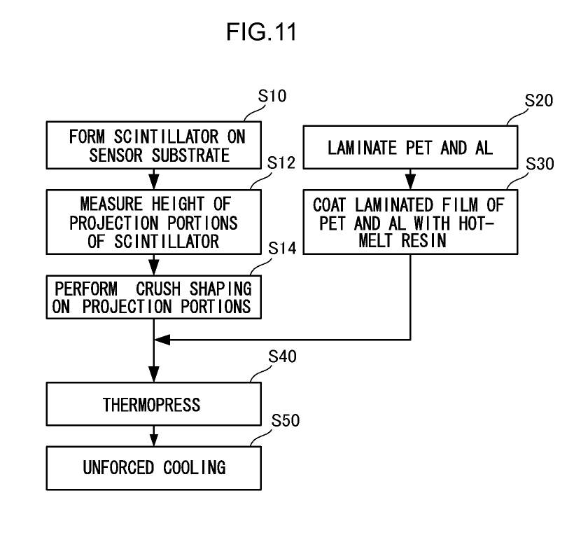

FIG. 11 is a process flow diagram illustrating a manufacturing method of the radiation detecting device 10 of a second exemplary embodiment of the present invention. In FIG. 11, processes substantially the same as the processes according to the first exemplary embodiment (see FIG. 6) are appended with the same reference numerals, and duplicate explanation is omitted thereof.

In the manufacturing method of the second exemplary embodiment, in contrast to the processing flow according to the first exemplary embodiment (see FIG. 6), a measurement process to measure the height h of the projection portions 62 of the scintillator 32 (process S12), and a process of crush shaping to crush the projection portions 62 of the scintillator 32 and to reduce the height of the projection portions 62 (process S14), are added.

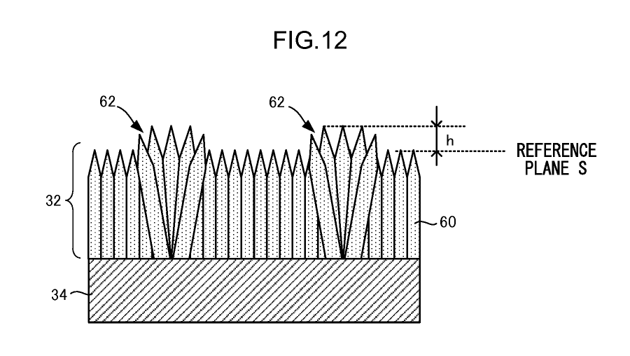

The process to measure the height h of the projection portions 62 of the scintillator 32 (process S12) is performed after forming the scintillator 32 to the sensor substrate 34, and prior to thermopress processing (process S40). The height h of the projection portions 62 of the scintillator 32 may, as illustrated in FIG. 12, be taken as the distance between the reference plane S defined by the leading ends of the columnar crystals 60 of the scintillator 32 formed without abnormal growth, and the leading ends of the projection portions 62. The height h of the projection portions 62 may, for example, be measured by employing a known profile measuring laser microscope or the like. At process S12, the maximum value, average value and the like of the height h of the plural projection portions 62 formed on the surface of the scintillator 32 may be derived. The process S12 is an example of a measurement process of the present invention.

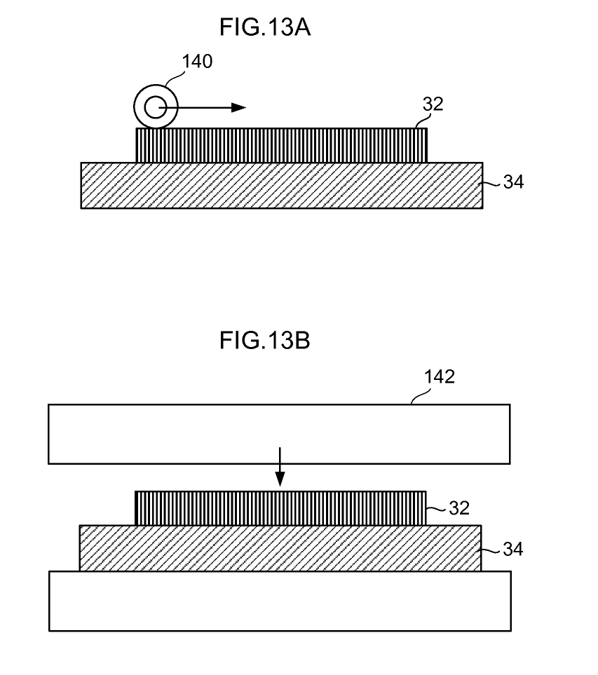

The process of crush shaping on the projection portions 62 of the scintillator 32 (process S14) is executed in continuation from the process S12. The crush shaping of the projection portions 62 may be performed by imparting pressing force to the projection portions 62. FIG. 13A and FIG. 13B are diagrams illustrating example of methods of the crush shaping of the projection portions 62. The crush shaping of the projection portions 62 may, for example as illustrated in FIG. 13A, be performed by contacting a roller 140 that applies a linear pressing force to the surface of the scintillator 32, and moving the roller 140 across the entire surface of the scintillator 32. As illustrated in FIG. 13B, the crush shaping may also be performed using a press plate 142 to apply a planar pressing force to the surface of the scintillator 32.

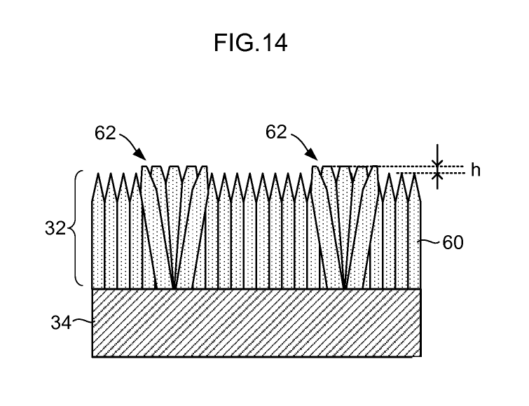

As illustrated in FIG. 14, by performing crush shaping to the projection portions 62, the leading ends of the projection portions 62 are crushed, and the height h of the projection portions 62 is reduced compared to before crush shaping. The height h of the projection portions 62 after crush shaping is preferably the thickness of the thermoplastic resin layer 50 (the hot-melt resin 50A) in the stacked-layer film 56A stacked with the thermoplastic resin layer 50 (the hot-melt resin 50A), the organic layer 52 (the PET film 52A), and the inorganic reflection layer 54 (the Al foil 54A), or less, and is more preferably less than the thickness of the thermoplastic resin layer 50 (the hot-melt resin 50A). There is a concern of gaps occurring between the scintillator 32 and the thermoplastic resin layer 50 (the hot-melt resin 50A) or between the thermoplastic resin layer 50 (the hot-melt resin 50A) and the organic layer 52 (the PET film 52A) when the stacked-layer film 56A has been bonded to the scintillator 32 if the height h of the projection portions 62 is greater than the thickness of the thermoplastic resin layer 50 (the hot-melt resin 50A) in the stacked-layer film 56A. Thus in the process S14, crush shaping is preferably performed such that the height h of the projection portions 62 becomes a specific threshold value or lower. For example, the thickness of the thermoplastic resin layer 50 (the hot-melt resin 50A) in the stacked-layer film 56A may be employed as the threshold value.

In order to achieve the height h of the projection portions 62 after the crush shaping of the specific threshold value or lower, the pressing force applied to the surface of the scintillator 32 in the crush shaping may be set according to the height h of the projection portions 62 acquired in the process S12. For example, the pressing force applied to the surface of the scintillator 32 may be increased the higher the average value and the maximum value of the height h of the projection portions 62 measured in the process S12. Moreover, crush shaping of the projection portions 62 (process S14) and measurement of the height h of the projection portions 62 (process S12) may be executed repeatedly until the height h of the projection portions 62 achieves the specific threshold value or lower. The crush shaping of the projection portions 62 may be executed in cases in which the average value and the maximum value of the height h of the projection portions 62 measured at process S12 are higher than the specific threshold value. Crush shaping of the projection portions 62 may also be performed without measuring height h of the projection portions 62. The process S14 is an example of a crush shaping process of the present invention.

In the process S40, thermopress processing is performed on the stacked-layer film 56A of the stacked thermoplastic resin layer 50 (the hot-melt resin 50A), the organic layer 52 (the PET film 52A), and the inorganic reflection layer 54 (the Al foil 54A) produced by the process S20 and process S30, and on the scintillator 32 that has been subjected to the crush shaping.

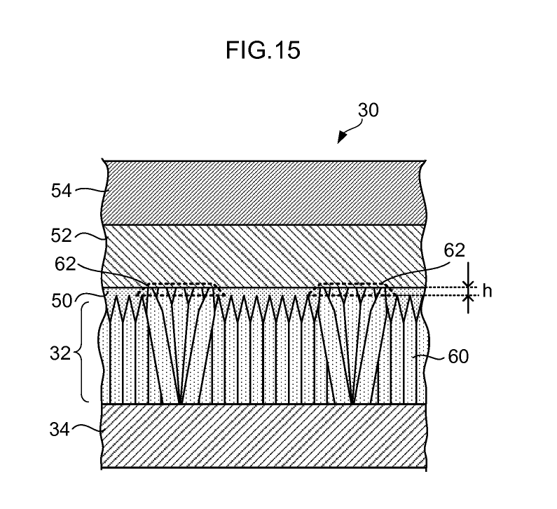

FIG. 15 is a partial cross-section of a configuration of the radiation detection panel 30 manufactured by the manufacturing method according to the second exemplary embodiment. Due to the crush shaping being performed on the projection portions 62 of the scintillator 32, at least some of the leading ends of the crushed projection portions 62 pierce through the thermoplastic resin layer 50 and make contact with the organic layer 52. In cases in which the height of the crushed plural projection portions 62 is uneven, the leading ends of high projection portions 62, having the highest height out of the plural crushed projection portions 62, pierce through the thermoplastic resin layer 50 and make contact with the organic layer 52. Due to being able to make the height h of the projection portions 62 lower by subjecting the projection portions 62 to crush shaping, the distance between the scintillator 32 and the inorganic reflection layer 54 can be made smaller, and the sharpness of the obtained radiographic images can be raised. The height of the projection portions 62 can be controlled by subjecting the projection portions 62 to the crush shaping, enabling manufacturing variance in the distance between the scintillator 32 and the inorganic reflection layer 54 to be reduced.

### Third Exemplary Embodiment

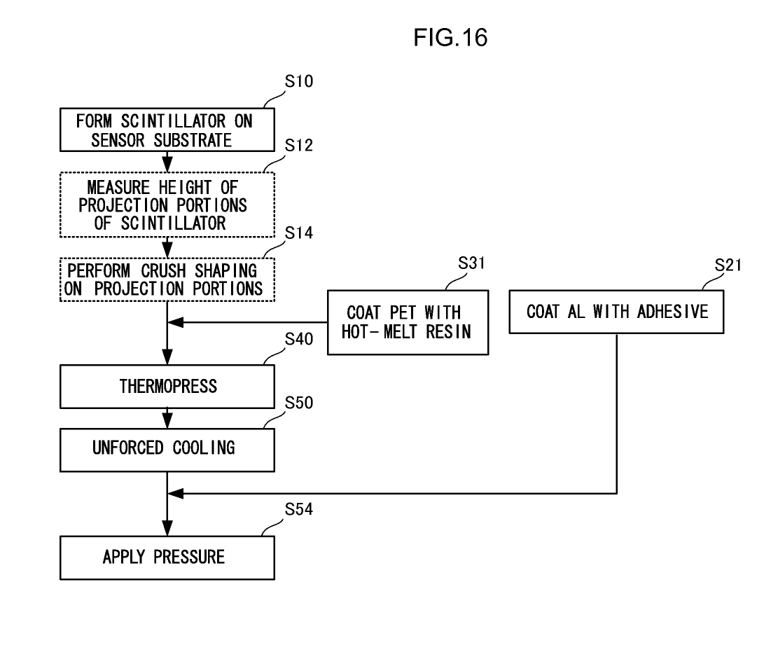

FIG. 16 is a process flow diagram illustrating a manufacturing method of a radiation detecting device 10 according to a third exemplary embodiment of the present invention. In FIG. 16, processes substantially the same as the processes of the first exemplary embodiment (see FIG. 6) and the processes of the second exemplary embodiment (see FIG. 11) are appended with the same reference numerals, and duplicate explanation is omitted thereof. The manufacturing method of the third exemplary embodiment differs from the manufacturing methods of the first and second exemplary embodiments described above in the point that a stacked-layer film stacked with the thermoplastic resin layer 50 (hot-melt resin) and the organic layer 52 (PET film) is manufactured, and after the stacked-layer film and the scintillator 32 have been bonded together, an inorganic reflection layer 54 (Al foil) is bonded onto the organic layer 52 (PET film).

In a process S31, the coating device 120 illustrated in FIG. 8, or the like, is employed, and a stacked-layer film with the thermoplastic resin layer 50 (hot-melt resin) coated onto the organic layer 52 (PET film) is produced. In the manufacturing method according to the present exemplary embodiment, stacked-layer film with the thermoplastic resin layer 50 (hot-melt resin) coated onto the organic layer 52 (PET film) is produced, however a pre-made externally fabricated stacked-layer film may be employed. In such cases the process S31 to manufacture the stacked-layer film can be omitted.

In the process S40, the stacked-layer film produced in the process S31 is disposed over the scintillator 32 formed on the sensor substrate 34, and thermopress processing is performed using the presses illustrated in FIG. 10A or FIG. 10B, or the like. Then, at step S50, the thermoplastic resin layer 50 (the hot-melt resin 50A) is cured by unforced cooling.

At step S21, one face of the inorganic reflection layer 54 (Al foil) is coated with an adhesive. Then, at step S54, the inorganic reflection layer 54 (Al foil) is bonded onto the organic layer 52 (PET film) by placing the inorganic reflection layer 54 (Al foil) in contact with the organic layer 52 (PET film) of the stacked-layer film bonded to the scintillator 32, and applying pressure. Note that the process to measure the height h of the projection portions 62 of the scintillator 32 (process S12), and the process to perform crush shaping of the projection portions 62 of the scintillator 32 (process S14) may be omitted.

Thereby, a radiation detection panel 30 manufactured with the same structure as that illustrated in FIG. 5 to FIG. 15 can be also be obtained in cases in which the inorganic reflection layer 54 (Al foil) is bonded onto the organic layer 52 (PET film) after the stacked-layer film, configured from the thermoplastic resin layer 50 (the hot-melt resin) and the organic layer 52 (PET film), has been bonded to the scintillator 32.

### Fourth Exemplary Embodiment

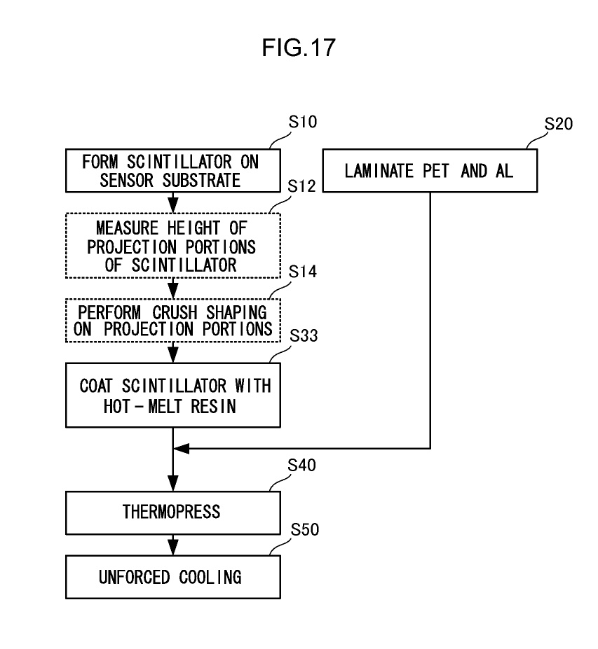

FIG. 17 is a process flow diagram illustrating a manufacturing method of a radiation detecting device 10 according to a fourth exemplary embodiment of the present invention. In FIG. 17, processes substantially the same as the processes according to the first exemplary embodiment (see FIG. 6) or the processes according to the second exemplary embodiment (see FIG. 11) are appended with the same reference numerals, and duplicate explanation is omitted thereof. The manufacturing method of the fourth exemplary embodiment differs from the manufacturing methods according to the first to third exemplary embodiments in the point that a process of directly coating the thermoplastic resin layer 50 onto the scintillator 32 (process S33) is included, and a stacked-layer film in which the thermoplastic resin layer 50 (hot-melt resin) is stacked with the organic layer 52 (PET film) is not supplied onto the scintillator 32.

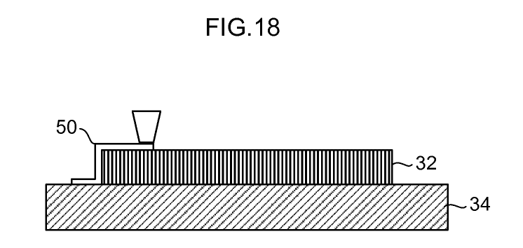

Namely, in a process S33, the thermoplastic resin layer 50 (hot-melt resin) melted by heating is coated onto the scintillator 32 formed on the sensor substrate 34, as illustrated in FIG. 18. The thermoplastic resin layer 50 (hot-melt resin) is coated so as to cover the top face and side faces of the scintillator 32, and onto the sensor substrate 34 at a peripheral portion to the scintillator 32. The process S33 is an example of the coating process of the present invention.

In the process S40, a laminated film of the organic layer 52 (PET film) laminated with the inorganic reflection layer 54 (Al foil) obtained at the process S20 is disposed on the thermoplastic resin layer 50 (hot-melt resin) coated onto the scintillator 32, and thermopress processing is performed using the presses illustrated in FIG. 10A or FIG. 10B, or the like.

Such a method in which the thermoplastic resin layer 50 (hot-melt resin) is not supplied onto the scintillator 32 in a stacked-layer film form stacked with the organic layer 52 (PET film), and instead the thermoplastic resin layer 50 (hot-melt resin) is directly coated onto the scintillator 32, also enables a radiation detection panel 30 configured with the same structure as that illustrated in FIG. 5 to FIG. 15 to be obtained.

In cases in which crush shaping is implemented such that in crush shaping performed on the projection portions 62 of the scintillator 32 at process S14, the average value or the maximum value of the height h of the projection portions 62 achieves a predetermined threshold value or lower, the coating thickness of the thermoplastic resin layer 50 (hot-melt resin) coated onto the scintillator 32 may be employed as the threshold value. Note that the process to measure the height h of the projection portions 62 of the scintillator 32 (process S12), and the process to perform crush shaping of the projection portions 62 of the scintillator 32 (process S14) may be omitted.

### Fifth Exemplary Embodiment

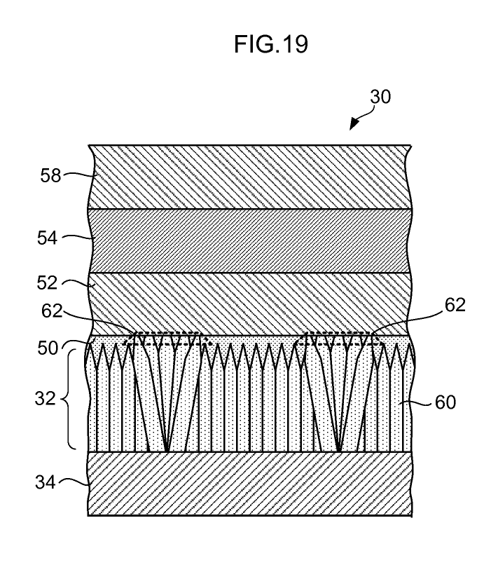

FIG. 19 is a partial cross-section illustrating a configuration of a radiation detection panel 30 according to a fifth exemplary embodiment of the present invention. The radiation detection panel 30 according to the fifth exemplary embodiment differs from the radiation detection panels 30 illustrated in FIG. 5 to FIG. 15 in that the a second organic layer 58 is further included on the inorganic reflection layer 54. The second organic layer 58 functions as a protection layer to protect the top face of the inorganic reflection layer 54. Examples of the material of the second organic layer 58 include polyethylene terephthalate (PET), polyphenylene sulfide (PPS), biaxial oriented polypropylene (OPP), polyethylene naphthalate (PEN), polyimide (PI), nylon (Ny), PC (polycarbonate), cast polypropylene (CPP), polyethylene (PE), and polyvinyl chloride (PVC). The second organic layer 58 may be configured from plural layers including the above material(s). Deterioration of the inorganic reflection layer 54 can accordingly be prevented by covering the top face of the inorganic reflection layer 54 with the second organic layer 58.

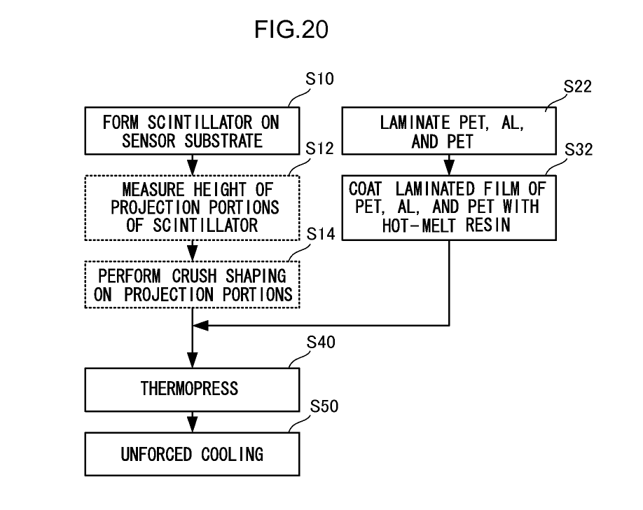

FIG. 20 is a process flow diagram illustrating a manufacturing method of the radiation detecting device 10 equipped with the radiation detection panel 30 according to the fifth exemplary embodiment. In FIG. 20, processes substantially the same as the processes according to the first exemplary embodiment (see FIG. 6) or the processes according to the second exemplary embodiment (see FIG. 11) are appended with the same reference numerals, and duplicate explanation is omitted thereof. The manufacturing method of the present exemplary embodiment differs from the process flow according to the first to the fourth exemplary embodiments in the point that processes to form a stacked-layer film including the second organic layer 58 to protect the top face of the inorganic reflection layer 54 (Al foil) are included (process S22 and process S32).

Namely, in the process S22, the first organic layer 52 (PET film), the inorganic reflection layer 54 (Al foil), and the second organic layer 58 (for example a PET film) are laminated together. In the process S32, a stacked-layer film is obtained in which the thermoplastic resin layer 50 (hot-melt resin) is coated onto the first organic layer 52 (PET film) side of the laminated film produced at step S22. At step S40, the stacked-layer film produced in the process S32 is disposed over the scintillator 32 formed on the sensor substrate 34, and thermopress processing is performed using the presses illustrated in FIG. 10A or FIG. 10B, or the like. Then, unforced cooling is performed at step S50, enabling the radiation detection panel 30 with the structure illustrated in FIG. 19 to be obtained.

In the present exemplary embodiment, a stacked-layer film is produced in which the thermoplastic resin layer 50 (hot-melt resin), the first organic layer 52 (PET film), the inorganic reflection layer 54 (Al foil), and the second organic layer 58 (PET film) are stacked together, and the stacked-layer film is bonded to the scintillator 32; however, the process flow thereof is not limited thereto. For example, a laminated film may be produced with the second organic layer 58 (PET film) laminated onto the inorganic reflection layer 54 (Al foil) in the process S21 of the process flow according to the third exemplary embodiment (see FIG. 16), and the first organic layer 52 (PET film) may then be bonded thereto after thermopress processing of the laminated film has been completed (process S40). Moreover, a laminated film may be produced in the process S20 of the process flow (see FIG. 17) according to the fourth exemplary embodiment in which the first organic layer 52 (PET film), the inorganic reflection layer 54 (Al foil), and the second organic layer 58 (PET film) are laminated together, and this laminated film then disposed over the thermoplastic resin layer 50 (hot-melt resin), and thermopress processing (process S40) executed.

### Modified Examples

Examples have been given in each of the above exemplary embodiments in which a hot-melt resin is employed as the thermoplastic resin layer 50, however a resin other than a hot-melt resin may also be employed. Examples of such thermoplastic resins other than a hot-melt resin include polyethylene (PE: melting point 136° C., Young's modulus 0.2 GPa), and polybutene (PB: melting point 125° C., Young's modulus 0.5 GPa). Such thermoplastic resins that do not belong to the category of the hot-melt resins do not have an adhesive function, and so an adhesive needs to be interposed between the scintillator 32 and the thermoplastic resin layer 50, and between the thermoplastic resin layer 50 and the organic layer 52. Examples of such adhesives include TAKELAC A626/TAKENATE 50 (manufactured by Mitsui Chemicals Inc., TAKELAC and TAKENATE are registered trademarks), and ADCOAT TM-569/CAT-RT37-0.8K (manufactured by Toyo-Morton Ltd., ADCOAT is a registered trademark).

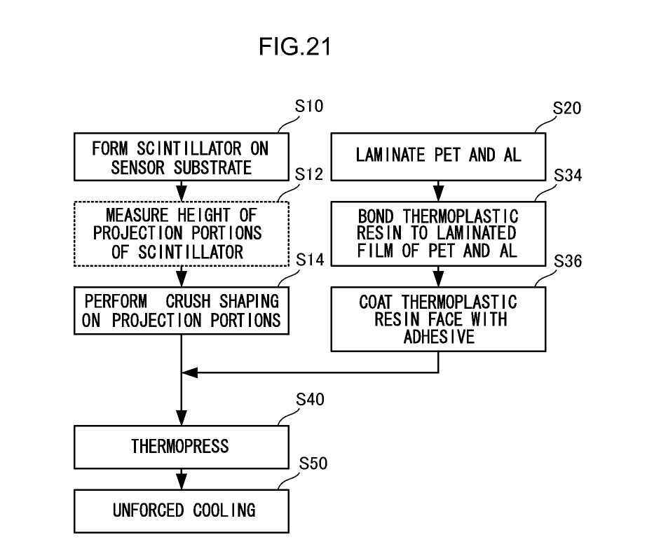

FIG. 21 is a process flow diagram illustrating a manufacturing method in cases in which a material other than a hot-melt resin is employed as the thermoplastic resin layer 50. In FIG. 21, processes that are substantially the same as processes according to the first exemplary embodiment (see FIG. 6) and the second exemplary embodiment (see FIG. 11) are appended with the same reference numerals and duplicate explanation is omitted thereof.

In the process S34, adhesive is applied to the organic layer 52 (PET film) side face of the laminated film produced at process S20 with the organic layer 52 (PET film) and the inorganic reflection layer 54 (Al foil) laminated together, and the thermoplastic resin layer 50 is bonded onto the organic layer 52. A stacked-layer film is thereby obtained including the thermoplastic resin layer 50 (for example PE), the organic layer 52 (PET film), and the inorganic reflection layer 54 (Al foil). At process S36, adhesive is coated onto the thermoplastic resin layer 50 (PE) of the stacked-layer film.

At process S40, thermopress processing is performed on the stacked-layer film obtained in process S36 by contacting the adhesive coated face onto the scintillator 32 formed on the sensor substrate 34 using the presses illustrated in FIG. 10A or FIG. 10B, or the like. This thereby enables a thermoplastic resin other than a hot-melt resin to be employed as the configuration member of the thermoplastic resin layer 50 by interposing adhesive between the thermoplastic resin layer 50 and the organic layer 52, and between the thermoplastic resin layer 50 and the scintillator 32. The adhesive interposed between the scintillator 32 and the thermoplastic resin layer 50 may be coated onto the scintillator 32 side.

Configuration may be made such that, in cases in which the configuration member of the thermoplastic resin layer 50 is coated directly onto the scintillator 32 as in the process flow according to the fourth exemplary embodiment (see FIG. 17), coating of the thermoplastic resin layer 50 is performed after the adhesive has been coated onto the surface of the scintillator 32, and a laminated film with adhesive coated onto the organic layer 52 (PET film) side of the laminated film, obtained at process S20 by laminating the organic layer 52 (PET film) and the inorganic reflection layer 54 (Al foil) together, is stuck to the thermoplastic resin layer 50, and then thermopress processing (process S40) is executed.

Although explanation has been given above of cases in which application is made to a radiation detecting device including the portable electronic cassette of the present invention, there is no limitation thereto. For example, the present invention may be applied, to a radiation detecting device installed inside an upright table or reclining table. The present invention may also be applied to a mammography device, or a radiation detecting device employed in dentistry.

What is claimed is:

1. A radiation detecting device comprising:
a scintillator that converts radiation into light;
a substrate that supports the scintillator and includes a plurality of sensor portions that generate charges according to the light converted by the scintillator;
a thermoplastic resin layer provided on the scintillator;
a first organic layer provided on the thermoplastic resin layer; and
an inorganic reflection layer provided on the first organic layer, wherein
the melting start temperature of the thermoplastic resin layer is lower than the melting start temperature of the first organic layer, the scintillator includes a projection portion on a surface on the side provided with the thermoplastic resin layer, and a leading end of the projection portion penetrates the thermoplastic resin layer and makes contact with the first organic layer.

2. The radiation detecting device of claim 1, wherein:
the scintillator includes a plurality of projection portions on the surface on the side provided with the thermoplastic resin layer; and
leading ends of at least some of the plurality of projection portions penetrate through the thermoplastic resin layer and make contact with the first organic layer.

3. The radiation detecting device of claim 1, wherein:
the scintillator includes a plurality of projection portions that project out further than other portions on the surface on the side provided with the thermoplastic resin layer; and
at least some of the plurality of projection portions out of the plurality of projection portions are crushed, and leading ends of at least some of the crushed projection portions penetrate through the thermoplastic resin layer and make contact with the first organic layer.

4. The radiation detecting device of claim 1, wherein:
the scintillator includes a plurality of columnar crystals; and
the projection portion is configured including a leading end portion of at least one columnar crystal higher than the average height of the plurality of columnar crystals.

5. The radiation detecting device of claim 1, wherein:
the thermoplastic resin layer is configured including a hot-melt resin.

6. The radiation detecting device of claim 1, further comprising:
a second organic layer provided on the inorganic reflection layer.

7. A manufacturing method of a radiation detecting device, the manufacturing method comprising:
a forming process in which a scintillator is formed on a substrate;
a preparation process in which a multi-layer is prepared including a thermoplastic resin layer that starts to melt at a first temperature and a first organic layer that starts to melt at a second temperature higher than the first temperature;
a thermopress process in which the multi-layer is disposed on the scintillator such that the scintillator and the thermoplastic resin layer make contact with each other, and the multi-layer is pressed toward the scintillator while heating to a temperature higher than the first temperature and lower than the second temperature such that a projection portion of the scintillator penetrates the thermoplastic resin layer and makes contact with the first organic layer; and
after the thermopress process, a process in which an inorganic reflection layer is formed on the first organic layer.

8. A manufacturing method of a radiation detecting device, the manufacturing method comprising:
a forming process in which a scintillator is formed on a substrate;
a preparation process in which a multi-layer is prepared including a thermoplastic resin layer that starts to melt at a first temperature, a first organic layer that is provided on the thermoplastic resin layer and starts to melt at a second temperature higher than the first temperature, and an inorganic reflection layer that is provided on the first organic layer; and
a thermopress process in which the multi-layer is disposed on the scintillator such that the scintillator and the thermoplastic resin layer make contact with each other, and the multi-layer is pressed toward the scintillator while heating to a temperature higher than the first temperature and lower than the second temperature such that a projection portion of the scintillator penetrates the thermoplastic resin layer and makes contact with the first organic layer.

9. The manufacturing method of claim 8, wherein a multi-layer is prepared in the preparation process further including a second organic layer provided on the inorganic reflection layer.

10. A manufacturing method of a radiation detecting device, the manufacturing method comprising:
a forming process in which a scintillator is formed on a substrate;
a covering process in which a surface of the scintillator is covered by a thermoplastic resin layer that starts to melt at a first temperature;
a thermopress process in which a layer including a first organic layer that starts to melt at a second temperature higher than the first temperature and an inorganic reflection layer provided on the first organic layer is disposed on the thermoplastic resin layer, and the first organic layer is pressed toward the scintillator while heating thermoplastic resin layer to a temperature higher than the first temperature and lower than the second temperature such that a projection portion of the scintillator penetrates the thermoplastic resin layer and makes contact with the first organic layer.

11. The manufacturing method of claim 10, wherein in the thermopress process a layer including a second organic layer provided on the inorganic reflection layer is disposed on the thermoplastic resin layer.

12. The manufacturing method of claim 7, further comprising a crush shaping process that is performed prior to the thermopress process and in which the projection portion is crushed and the height of the projection portion is reduced.

13. The manufacturing method of claim 12, wherein in the crush shaping process the projection portion is crushed such that the height of the projection portion achieves a specific threshold value or lower.

14. The manufacturing method of claim 13, wherein in the crush shaping process the projection portion is crushed such that the height of the projection portion is reduced to the thickness of the thermoplastic resin layer or lower.

15. The manufacturing method of claim 12, further comprising:
a measurement process that is performed prior to the thermopress process and in which the height of the projection portion is measured; and
the crush shaping process is performed in cases in which the height of the projection portion measured in the measurement process is higher than a specific threshold value.

16. The manufacturing method of claim 12, further comprising:
a measurement process that is performed prior to the thermopress process and in which the height of the projection portion is measured; and
the crush shaping process includes processing to impart pressing force to the projection portion, wherein the pressing force is determined based on the height of the projection portion measured in the measurement process.

17. The manufacturing method of claim 7, wherein the thermoplastic resin layer is configured including a hot-melt resin.

18. The manufacturing method of claim 8, further comprising a crush shaping process that is performed prior to the thermopress process and in which the projection portion is crushed and the height of the projection portion is reduced.

19. The manufacturing method of claim 18, wherein in the crush shaping process the projection portion is crushed such that the height of the projection portion achieves a specific threshold value or lower.

20. The manufacturing method of claim 19, wherein in the crush shaping process the projection portion is crushed such that the height of the projection portion is reduced to the thickness of the thermoplastic resin layer or lower.

21. The manufacturing method of claim 18, further comprising:
a measurement process that is performed prior to the thermopress process and in which the height of the projection portion is measured; and
the crush shaping process is performed in cases in which the height of the projection portion measured in the measurement process is higher than a specific threshold value.

22. The manufacturing method of claim 18, further comprising:
a measurement process that is performed prior to the thermopress process and in which the height of the projection portion is measured; and
the crush shaping process includes processing to impart pressing force to the projection portion, wherein the pressing force is determined based on the height of the projection portion measured in the measurement process.

23. The manufacturing method of claim 8, wherein the thermoplastic resin layer is configured including a hot-melt resin.

24. The manufacturing method of claim 10, further comprising a crush shaping process that is performed prior to the thermopress process and in which the projection portion is crushed and the height of the projection portion is reduced.

25. The manufacturing method of claim 24, wherein in the crush shaping process the projection portion is crushed such that the height of the projection portion achieves a specific threshold value or lower.

26. The manufacturing method of claim 25, wherein in the crush shaping process the projection portion is crushed such that the height of the projection portion is reduced to the thickness of the thermoplastic resin layer or lower.

27. The manufacturing method of claim 24, further comprising:
a measurement process that is performed prior to the thermopress process and in which the height of the projection portion is measured; and
the crush shaping process is performed in cases in which the height of the projection portion measured in the measurement process is higher than a specific threshold value.

28. The manufacturing method of claim 24, further comprising:
a measurement process that is performed prior to the thermopress process and in which the height of the projection portion is measured; and
the crush shaping process includes processing to impart pressing force to the projection portion, wherein the pressing force is determined based on the height of the projection portion measured in the measurement process.

29. The manufacturing method of claim 10, wherein the thermoplastic resin layer is configured including a hot-melt resin.
